(19) United States
(12) Patent Application Publication
(10) Pub. No.: US 2011/0148882 A1
(43) Pub. Date: Jun. 23, 2011

(54) FIRE SIMULTATION METHOD WITH PARTICLE FUEL

(75) Inventors: Byung Seok Roh, Daejeon (KR); Seung Hyup Shin, Daejeon (KR); Soon Hyoung Pyo, Daejeon (KR); Bon Ki Koo, Daejeon (KR)

(73) Assignee: Electronics and Telecommunications Research Institute, Daejeon (KR)

(21) Appl. No.: 12/857,940

(22) Filed: Aug. 17, 2010

(30) Foreign Application Priority Data
Dec. 18, 2009 (KR) 10-2009-0127343

(51) Int. Cl. G06T 11/20

(52) U.S. Cl. 345/440

(57) ABSTRACT

Disclosed is a fire simulation method using particle fuel. The fire simulation method includes: preparing a grid and a fuel particle in an initial state; calculating speed of the fuel particle by using the speed of the grid; calculating advection of the fuel particle; tracking and finding a fuel surface; setting temperature at the fuel surface; calculating buoyancy generated by the combustion of the fuel particle; calculating a vortex effect generated by the combustion of the fuel particle; calculating the speed of the grid meeting a incompressible condition based on a calculated result value for the buoyancy and the vortex effect; and obtaining a result of temperature transition from the change in temperature field advection and temperature based on the speed of the grid meeting the incompressible condition.

### CROSS-REFERENCE TO RELATED APPLICATIONS

This application claims priority under 35 U.S.C. §119 to Korean Patent Application No. 10-2009-0127343, filed on Dec. 18, 2009, in the Korean Intellectual Property Office, the disclosure of which is incorporated herein by reference in its entirety.

### BACKGROUND OF THE INVENTION

1. Field of the Invention

The present invention relates to fire simulation among fluid simulations, and more particularly, to a fire simulation method using particle fuel.

2. Description of the Related Art

In a computer graphics field, modeling natural phenomena such as fire and flame have been a challenge. As a representative method for simulating fire in the computer graphics field, there is a method of representing fuel on a grid using a level set method and a method for simulating combustion on a fuel surface. Since the fuel surface is an important factor that determines the entire shape of fire, it is important to define the combustion surface so as to simulate fire.

### SUMMARY OF THE INVENTION

It is an object of the present invention to provide a fire simulation method capable of more violently and graphically simulating combustion of fuel using fuel particle.

In order to solve the above technical problem, according to an exemplary embodiment of the present invention, there is provided a fire simulation method, including: preparing a grid and a fuel particle in an initial state; calculating a speed of the fuel particle by using the speed of the grid; calculating advection of the fuel particle; tracking and finding a fuel surface; setting temperature at the fuel surface; calculating buoyancy generated by the combustion of the fuel particle; calculating a vortex effect generated by the combustion of the fuel particle; calculating the speed of the grid meeting a incompressible condition based on the calculated result value for the buoyancy and the vortex effect; and obtaining a result of temperature transition from the temperature field advection and the change of temperature, based on the speed of the grid meeting the incompressible condition.

According to another exemplary embodiment of the present invention, there is provided a fire simulation method, including: calculating a speed for each fuel particle by using the speed of a grid during fire simulation; calculating a fuel surface of the fuel particle; setting the temperature to a grid at the fuel surface; calculating the speed of a grid meeting the incompressible condition over the entire grid; calculating buoyancy by the combustion of the fuel particle; and calculating a vortex effect by the combustion of the fuel particle.

The calculating the speed for each fuel particle using the speed of the grid may include calculating the Equation uₚ(i)=u(x,y,z,t) that represents the speed of the i-th fuel particle uₚ(i) positioned at the center of the (x,y,z) grid at time t.

The calculating the fuel surface of the fuel particle may include calculating the Equation

$$∇ \cdot {r}_{a} = {\sum }_{b} \frac{{m}_{b}}{{ρ}_{b}} ( {r}_{a} - {r}_{b} ) \cdot {∇}_{a} W ( \vert {r}_{a} - {r}_{b} \vert , h ) ,$$

where m_{b} represents a mass of b-th particle, ρ_{b} represents density, and W(r,h) represents a smoothing kernel function with respect to a radius h, rₐ represents a position of a particle a, and r_{b} represents a position of h.

The setting the temperature to the grid at the fuel surface may include calculating Equation T(x,y,z,t)=Tₘₐₓ, where the T(x,y,z,t) represents temperature stored in a (x,y,z) grid when the particle positioned at the center of the (x,y,z) grid is combusted at a time t and the Tₘₐₓ represents the maximum temperature of the fuel particle.

The calculating the speed of a grid meeting the incompressible condition over the entire grid may include calculating the Equation

$${u}^{n + 1} = {u}^{*} - \frac{Δ t}{ρ} Δ p$$

by obtaining

$${∇}^{2} p = \frac{ρ}{∇ t} ∇ \cdot {u}^{*}$$

in a Poission equation type by substituting a previously calculated temporary speed u* into Equation ∇·u=0 meeting the incompressible state and by substituting pressure p meeting it, where u* represents a temporary speed between a speed uⁿ of n-th time and a speed uⁿ⁺¹ of n+1-th time where pressure is not applied and Δt represents a simulation time interval.

The calculating the buoyancy by the combustion of the fuel particle may include calculating the Equation f_{buoy}=α(T−Tₐᵢᵣ)z, where z represents an up vector, T represents current temperature, Tₐᵢᵣ represents normal temperature, and α is a positive constant.

The calculating the vortex effect by the combustion of the fuel particle may include calculating the Equation f_{conf}=ε(N×ω), where ε is a value larger than 0 and is a constant determining how large the vorticity confinement is applied and ω represents a vortex having a small size at the speed field.

According to the present invention, it can provide a fire simulation method using particle fuel and improves the method of representing fuel by simulating fire using the existing level set method. According to the present invention, it can more graphically simulate fire.

### BRIEF DESCRIPTION OF THE DRAWINGS

FIG. 1 is a flow chart showing a fire simulation process according to the related art representing fuel using a level set method;

FIG. 2 is a flow chart showing a fire simulation method using particle fuel according to an exemplary embodiment of the present invention;

FIG. 3 is a graph showing a kernel applied to the fire simulation of FIG. 2; and

FIG. 4 is a graph showing the change in temperature in simulating fire during the process where gas fuel is combusted to gas products.

### DETAILED DESCRIPTION OF THE PREFERRED EMBODIMENTS

Hereinafter, exemplary embodiments of the present invention will be described in detail with reference to the accompanying drawings and contents to be described below. Therefore, the present invention may be modified in many different forms and it should not be limited to the embodiments set forth herein. Rather, the exemplary embodiments set forth herein are provided to a person of ordinary skilled in the art to thoroughly and completely understand contents disclosed herein and fully provide the spirit of the present invention. Like reference numerals designate like components throughout the specification. Meanwhile, terms used in the present invention are to explain exemplary embodiments rather than limiting the present invention. In the specification, a singular type may also be used as a plural type unless stated specifically. “Comprises” and/or “comprising” used herein does not exclude the existence or addition of one or more other components, steps, operations and/or elements.

In order to understand fire simulation according to an exemplary embodiment of the present invention, a fire simulation process of the related art will be described.

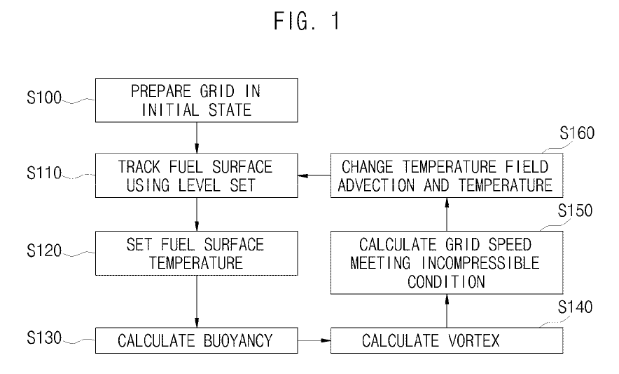

FIG. 1 is a flow chart showing a fire simulation process of the related art representing fuel using a level set method.

Referring to FIG. 1, the fire simulation method of the related art includes preparing a grid in an initial state (S100), tracking a fuel surface based on a level set for the fire simulation (S110), setting a fuel surface temperature (S120), calculating buoyancy (S130), calculating vortex (S140), calculating a speed of grid meeting a incompressible condition (S150), and changing temperature field advection and temperature (S160).

In the exemplary embodiment, advection represents a process where pressure, temperature, density, momentum, and so on, are changed or a rate changes in values over time that are generated at any point during the changing process.

The fire simulation method of the related art generally uses Navier-Stokes equation for simulating the combustion of fuel. The fire simulation method of the related art has limitation in simulating the violent motion of fire and flame graphically.

FIG. 2 is a flow chart showing a fire simulation method using particle fuel according to an exemplary embodiment of the present invention.

Referring to FIG. 2, the fire simulation method according to the exemplary embodiment includes preparing a grid in an initial state (S200), correcting a speed of particle using a speed of grid for fire simulation (S210), advecting fuel particle (S220), tracking fuel surface (S230), setting fuel surface temperature (S240), calculating buoyancy (S250), calculating vortex (S260), calculating a speed of grid meeting a incompressible condition (S270), and changing temperature field advection and temperature (S280).

In the exemplary embodiment of the present invention, in order to simulate the graphical motion of fire, the motion of fire is calculated to be numerically approximate by using Euler equation instead of the Navier-stokes equation including viscosity. When a (x,y,z) grid-centered fluid speed is represented by u(x,y,z,t) at time t and the differentiation of the u(x,y,z,t) for time is represented by uₜ, the Euler equation meeting the incompressible state is represented by the following Equations 1 and 2.

$$\begin{matrix}{u}_{t} = - ( u \cdot ∇ ) u - \frac{∇ p}{ρ} + f & [ Equation 1 ] \\ ∇ \cdot u = 0 & [ Equation 2 ]\end{matrix}$$

where ρ represents density, p represents hydrostatic pressure, f represents external force such as gravity, buoyancy, surface tension, etc. Equation 1 is the Euler equation defining a flow of fluid and Equation 2 represents volume conservation of fluid.

The most important factor for simulating fire is the fuel simulation. The fire simulation method of the related art represents fuel on the grid using the level set method, while the fire simulation method according to the exemplary embodiment simulates the violent motion of fire using the particle as fuel (S200).

The speed uₚ(i) of i-th fuel particle speed that is positioned at the center of the (x,y,z) grid at time t depends on the following Equation 3 (S210).

uₚ(i)=u(x,y,z,t) [Equation 3]

The speed of the particle that is not positioned at the center of the grid (x,y,z) refers to the speed of the peripheral grid and is then interpolated and calculated.

In simulating fuel, since a portion of where fuel is combusted is the fuel surface contacting air, the fuel surface is searched and then, the speed at the fuel surface should be defined, in order to simulate fuel. In order to calculate the fuel surface, the exemplary embodiment is calculated according to the following Equation 4 (S220).

$$∇ \cdot {r}_{a} = {\sum }_{b} \frac{{m}_{b}}{{ρ}_{b}} ( {r}_{a} - {r}_{b} ) \cdot {∇}_{a} W ( \vert {r}_{a} - {r}_{b} \vert , h ) \qquad [ Equation 4 ]$$

m_{b} represents a mass of b-th particle, ρ_{b} represents density, and W(r,h) represents a smoothing kernel function with respect to a radius h. In addition, rₐ represents a position of a particle a and r_{b} represents a position of a particle b. In the exemplary embodiment, the case where the value calculated according to Equation 4 is 2 or less is determined as the fuel surface in the 2D simulation (S230).

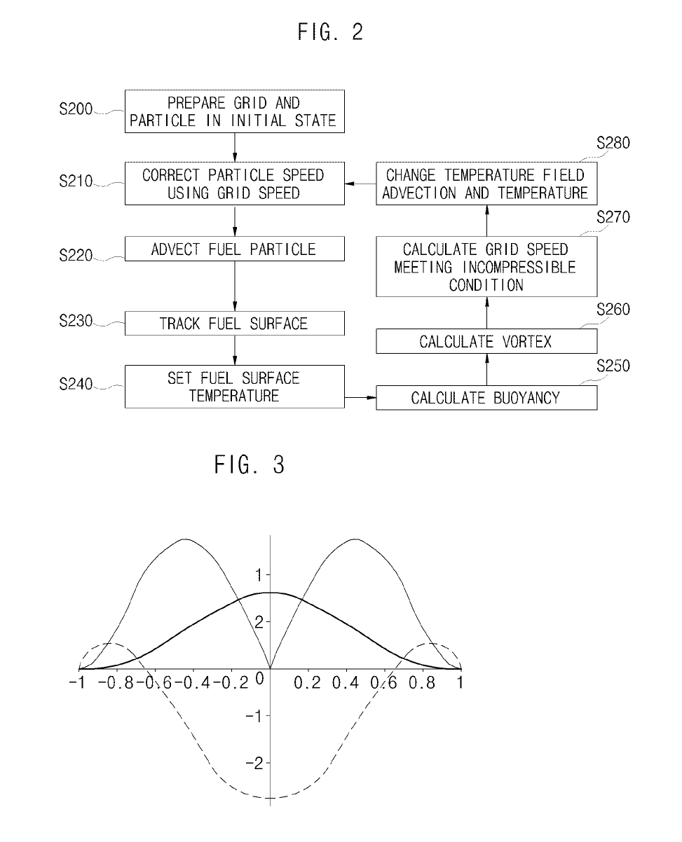

FIG. 3 is a graph showing a kernel applied to the fire simulation of FIG. 2.

The graph of FIG. 3 shows the shape of the smoothing kernel function W(r,h). The smoothing kernel function W(r,h) meets the following Equation 5.

W(r,h)=W(−r,h) [Equation 5]

After the fuel surface is calculated according to Equation 4, since the particle positioned at the fuel surface is removed by the combustion action, the motion of the particle positioned at the fuel surface is not calculated any more. Meanwhile, the combusted particle is converted into thermal energy which is in turn transferred to the grid. When the particle that is positioned at the center of the (x,y,z) grid at time t is combusted, the temperature stored in the (x,y,z) grid is represented by T(x,y,z,t), which is defined by Equation 6 (S240).

T(x,y,z,t)=Tₘₐₓ [Equation 6]

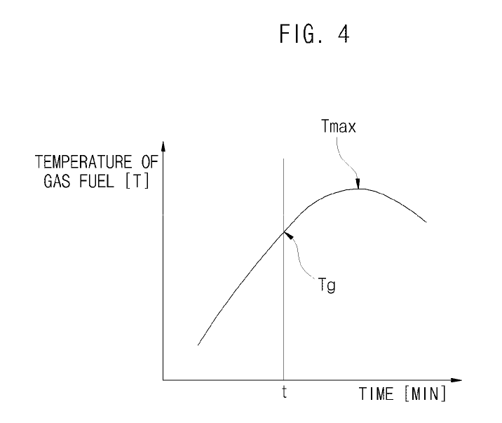

FIG. 4 is a graph showing the change in temperature while simulating fire during the process where gas fuel combust as gas products.

In FIG. 4, the graph shows the change in flame temperature for gas fuel and Tₘₐₓ represents the maximum temperature. The gas fuel starts to combust when the temperature gradually increases and becomes ignition temperature Tign. Thereafter, if the temperature passes through the maximum temperature, the temperature falls.

The shape of fire can be seen with eyes when the high-temperature material is visible to eyes as a spectral generated by black body radiation. As a result of the characteristics, the process to simulate the transition of temperature is needed in order to simulate and visualize fire. In the exemplary embodiment, the transition in temperature on the grid is simulated using the speed of the grid calculated by Equations 1 and 2.

In the exemplary embodiment, Equation 1 is solved by being Equations 7 and 8.

$$\begin{matrix}\frac{{u}^{*} - {u}^{n}}{Δ t} = - ( {u}^{n} \cdot ∇ ) {u}^{n} + f & [ Equation 7 ] \\ \frac{{u}^{n + 1} - {u}^{*}}{Δ t} = - \frac{∇ p}{ρ} & [ Equation 8 ]\end{matrix}$$

In Equation 7, u* represents a temporary speed between a speed uⁿ of n-th time and a speed uⁿ⁺¹ of n+1-th time where pressure is not applied and Δt represents a simulation time interval. In the exemplary embodiment, in order to calculate −(uⁿ·∇)uⁿ, a semi-Lagrangian method is used, wherein the buoyancy or vorticity confinement force applied to the external force f will be described below.

Since u* is calculated according to Equation 7 and then, ∇·uⁿ⁺¹ becomes 0 according to Equation 2, Equation 9 as a Poisson Equation type is derived by performing a divergence operation in Equation 8.

$${∇}^{2} p = \frac{ρ}{∇ t} ∇ \cdot {u}^{*} \qquad [ Equation 9 ]$$

Pressure p meeting the incompressible condition is calculated by solving Equation 9 and then, the final speed meeting the incompressible condition can be obtained according to Equation 10 (S270).

$${u}^{n + 1} = {u}^{*} - \frac{Δ t}{ρ} ∇ p \qquad [ Equation 10 ]$$

When the final speed meeting the incompressible condition is obtained according to Equation 10, the transition in temperature may be simulated. In the exemplary embodiment, according to Equation 11, the hot gas may be cooled over time (S280).

$${T}_{t} = - ( u \cdot ∇ ) T - {{C}_{T} ( \frac{T - {T}_{air}}{{T}_{max} - {T}_{air}} )}^{4} \qquad [ Equation 11 ]$$

At this time, −(u·∇)T represents advection of the temperature, C_{T} represents a speed constant when the temperature falls, and Tₐᵢᵣ represents a normal temperature.

The hot gas has a floating nature, which has an effect on the entire speed field. In the exemplary embodiment, the buoyancy is represented by f in Equation 1 and the buoyancy affecting the speed field depends on Equation 12 (S250).

f_{buoy}=α(T−Tₐᵢᵣ)z [Equation 12]

In FIG. 12, z represents an up vector, T represents current temperature, Tₐᵢᵣ represents normal temperature, α represents a positive constant and may determine the absolute size of the buoyancy. In other words, when the temperature is higher than the normal temperature, the buoyancy is applied to generate force that can float the hot gas.

Further, in the exemplary embodiment, the vorticity confinement method to generate the vortex effect is used in the fire simulation. First, in the velocity field, the vortex ω=∇×u having the small size is calculated and then N=∇|ω|/|∇|ω∥ calculated at the standard size to generate the vortex effect in each direction is calculated. The vorticity confinement can be calculated according to the following Equation 13 using the calculated result (S260).

f_{conf}=ε(N×ω) [Equation 13]

ε is a value larger than 0 and is a constant determining how large the vorticity confinement is applied to the velocity field.

The exemplary embodiment of the present invention is disclosed with reference to the detailed description and the drawings. Herein, specific terms have been used, but are just used for the purpose of describing the present invention and are not used for qualifying the meaning or limiting the scope of the present invention, which is disclosed in the appended claims. Therefore, it will be appreciated to those skilled in the art that various modifications are made and other equivalent embodiments are available. Accordingly, the actual technical protection scope of the present invention must be determined by the spirit of the appended claims.

What is claimed is:

1. A fire simulation method, comprising:
preparing a grid and a fuel particle in an initial state;
calculating a speed of the fuel particle using a speed of the grid;
calculating advection of the fuel particle;
tracking and finding a fuel surface;
setting temperature at the fuel surface;
calculating buoyancy generated by the combustion of the fuel particle;
calculating a vortex effect generated by the combustion of the fuel particle;
calculating the speed of the grid meeting a incompressible condition based on the calculated result value for the buoyancy and the vortex effect; and
obtaining a result of temperature transition from the temperature field advection and the change of temperature, based on the speed of the grid meeting the incompressible condition.

2. A fire simulation method, comprising:
calculating a speed for each fuel particle by using the speed of a grid in simulating fire;
calculating a fuel surface of the fuel particle;
setting temperature to a grid at the fuel surface;
calculating the speed of the grid meeting the incompressible condition over the entire grid;
calculating buoyancy by the combustion of the fuel particle; and
calculating a vortex effect by the combustion of the fuel particle.

3. The fire simulation method according to claim 2, wherein the calculating the speed for each fuel particle using the speed of the grid includes calculating Equation uₚ(i)=u(x,y,z,t) that represents the speed of the i-th fuel particle uₚ(i) positioned at the center of the (x,y,z) grid at time t.

4. The fire simulation method according to claim 2, wherein the calculating the fuel surface of the fuel particle includes calculating Equation
$$∇ \cdot {r}_{a} = {\sum }_{b} \frac{{m}_{b}}{{ρ}_{b}} ( {r}_{a} - {r}_{b} ) \cdot {∇}_{a} W ( \vert {r}_{a} - {r}_{b} \vert , h ) ,$$
where m_{b} represents a mass of b-th particle, ρ_{b} represents density, and W(r,h) represents a smoothing kernel function with respect to a radius h,rₐ represents a position of a particle a, and r_{b} represents a position of b.

5. The fire simulation method according to claim 2, wherein the setting the temperature to the grid at the fuel surface includes calculating Equation T(x,y,z,t)=Tₘₐₓ, where the T(x,y,z,t) represents temperature stored in a (x,y,z) grid when the particle positioned at the center of the (x,y,z) grid at time t is combusted and Tₘₐₓ represents the maximum temperature of the fuel particle.

6. The fire simulation method according to claim 2, wherein the calculating the speed of the grid meeting the incompressible condition over the entire grid includes calculating Equation
$${u}^{n + 1} = {u}^{*} - \frac{Δ t}{ρ} ∇ p$$
by obtaining
$${∇}^{2} p = \frac{ρ}{∇ t} ∇ \cdot {u}^{*}$$
in a Poission equation by substituting a previously calculated temporary speed u* into Equation ∇·u=0 meeting the incompressible state and by substituting pressure p meeting it, where u* represents a temporary speed between a speed uⁿ of n-th time and a speed uⁿ⁺¹ of n+1-th time where pressure is not applied and Δt represents a simulation time interval.

7. The fire simulation method according to claim 2, wherein the calculating the buoyancy by the combustion of the fuel particle includes calculating Equation f_{buoy}=α(T−Tₐᵢᵣ)z, where z represents an up vector, T represents current temperature, Tₐᵢᵣ represents normal temperature, and α is a positive constant.

8. The fire simulation method according to claim 2, wherein the calculating the vortex effect by the combustion of the fuel particle includes calculating Equation f_{conf}=ε(N×ω), where ε is a value larger than 0 and is a constant determining how large the vorticity confinement is applied and ω represents a vortex having a small size at the speed field.
